(19) United States
(12) Patent Application Publication
(10) Pub. No.: US 2021/0331680 A1
(43) Pub. Date: Oct. 28, 2021

(54) VEHICLE DRIVING ASSISTANCE APPARATUS

(71) Applicant: DENSO CORPORATION, Kariya-city (JP)

(72) Inventors: Shingo IMURA, Kariya-city (JP); Woocheol SHIN, Kariya-city (JP)

(21) Appl. No.: 17/369,207

(22) Filed: Jul. 7, 2021

Related U.S. Application Data
(63) Continuation of application No. PCT/JP2020/000305, filed on Jan. 8, 2020.

(30) Foreign Application Priority Data
Jan. 9, 2019 (JP) 2019-001927

(51) Int. Cl. B60W 40/06; B60W 30/18; B60W 50/14; B60K 35/00; G06K 9/00

(52) U.S. Cl. CPC B60W 40/06; B60W 30/18154; B60W 50/14; B60K 35/00; B60K 2370/1868; B60W 2552/05; B60W 2050/146; B60K 2370/166; B60K 2370/176; G06K 9/00805

(57) ABSTRACT

In a vehicle driving assistance apparatus, an approach recognizer is configured to recognize whether a vehicle has approached an intersecting road that is a road intersecting a road of travel on which the vehicle is traveling. A road surface recognizer is configured to recognize a road surface in an image of surroundings of the vehicle captured by a camera mounted to the vehicle. An image switcher is configured to, in response to the approach recognizer recognizing that the vehicle has approached the intersecting road, determine whether the road surface recognizer has recognized a road surface of the intersecting road, and in response to the road surface recognizer recognizing the road surface of the intersecting road, switch a display image on a display device mounted to the vehicle, for displaying driving guidance for the vehicle, to an image of the intersecting road captured by the camera.

### CROSS-REFERENCE TO RELATED APPLICATION

This international application claims the benefit of priority from Japanese Patent Application No. 2019-001927 filed with the Japan Patent Office on Jan. 9, 2019, the entire contents of which are incorporated herein by reference.

### BACKGROUND

### Technical Field

This disclosure relates to a vehicle driving assistance apparatus that provides driving assistance to a driver of a vehicle when the vehicle enters an intersection.

### Related Art

A vehicle driving assistance apparatus is known that is configured to, in response to detecting a subject vehicle, which is a vehicle carrying the vehicle driving assistance apparatus, entering a blind intersection, switch a display image on a display from a route guidance image to a side-view image captured by a right-side or left-side view blindspot camera.

### BRIEF DESCRIPTION OF THE DRAWINGS

In the accompanying drawings:

FIG. 1A is a block diagram of a vehicle driving assistance apparatus according to one embodiment;

FIG. 1B is a functional block diagram of an ECU;

FIG. 2 is an illustration of a mounting position of a front-view camera for imaging in a forward direction of a subject vehicle;

FIG. 3 is a flowchart of an image switching process performed by a CPU;

FIGS. 4A, 4B and 4C are examples of a stop line, a stop marking, and a stop sign, respectively; and

FIG. 5 is an illustration of switching display images according to the image switching process.

### DESCRIPTION OF SPECIFIC EMBODIMENTS

The above known vehicle driving assistance apparatus, as disclosed in JP-A-2007-140992, determines whether the subject vehicle will enter a blind intersection, based on an image looking in a forward direction of the subject vehicle captured by the front-view camera, and switches the display image to the side-view image in cases where there is an obstacle or building on the left or right side of a road of travel ahead of the subject vehicle.

The front-view camera is attached to a stay of a rearview mirror provided in the center of a vehicle cabin, and is configured to image in the forward direction, over a predefined left/right angle range, from the top center of the front windshield. The viewing angle is narrow.

Therefore, a determination as to whether to switch the display image to the side-view image is made at a location that is some distance away from the intersection and allows the front-view camera to image the vicinity of the intersection.

However, as a result of detailed research that was performed by the present inventors, an issue was found that, at a timing when the display image is switched to the side-view image in response to a determination being made that the subject vehicle will enter the blind intersection, the blindspot cameras may fail to image an intersecting road intersecting the road of travel.

That is, at a timing when the display image to display is switched to the side-view image, the subject vehicle may be away from the intersection, or the side-view image having only an obstacle appearing may be displayed on the display device due to the presence of the obstacle or the like on the left or right side of the road of travel. In such a case, it may not be possible to provide preferable driving assistance to the driver.

In addition, the blindspot cameras are attached to the left and right sides of the vehicle front end and are configured to image in the left and right directions of the front end. Thus, unlike the front-view camera, the blindspot cameras are unable to image the road of travel ahead of the subject vehicle.

There is another issue with the above vehicle driving assistance apparatus that, in addition to the blindspot cameras for imaging an intersecting road, a front-view camera for determining whether to switch display images has to be provided to detect whether the subject vehicle will enter a blind intersection.

In view of the foregoing, it is desired to have a vehicle driving assistance apparatus, which is able to, when the vehicle enters an intersection, display an image of an intersecting road without providing an additional camera for determining whether to switch display images, thereby providing appropriate driving assistance to a driver.

One aspect of the present disclosure provides a vehicle driving assistance apparatus including an approach recognizer configured to recognize whether a vehicle has approached an intersecting road that is a road intersecting a road of travel on which the vehicle is traveling.

A road surface recognizer is configured to, in response to the approach recognizer recognizing that the vehicle has approached the intersecting road, recognize a road surface in an image of surroundings of the vehicle captured by a camera mounted to the vehicle. An image switcher is configured to determine whether the road surface recognizer has recognized a road surface of the intersecting road.

The image switcher is configured to, in response to determining that the road surface recognizer has recognized the road surface of the intersecting road, switch a display image on a display device mounted to the vehicle, for displaying driving guidance for the vehicle, to an image of the intersecting road captured by the camera.

With this configuration, when a road surface of the intersecting road is imaged by the camera immediately before the vehicle enters an intersection, the vehicle driving assistance apparatus will switch the display image on the display to the image of the intersecting road captured by the camera.

That is, when the road surface of the intersecting road fails to be imaged by the camera due to the presence of an obstacle or the like around the intersection, the display image is not switched to the image captured by the camera. Therefore, it is possible to switch the display image at appropriate timings that allow the camera to image the road surface of the intersecting road.

Therefore, the driver can be aware of a condition of the intersecting road from the switched display image, that is, the captured image of the intersecting road, and this allows the vehicle to safely enter the intersection.

In the vehicle driving assistance apparatus according to the aspect of the present disclosure, the image captured by the camera used for road surface recognition is used as a driving assistance image to which the display image is switched.

Therefore, unlike the vehicle driving assistance apparatus disclosed in JP-A-2007-140992, it is not necessary to provide an additional camera used to determine whether to switch the display images, which allows simplification of the overall configuration of the vehicle driving assistance apparatus. In addition, the vehicle driving assistance apparatus according to the aspect of the present disclosure is applicable to vehicles not equipped with any camera used to determine whether to switch the display images, which can expand applications of the vehicle driving assistance apparatus.

One embodiment of the present disclosure will now be described with reference to the accompanying drawings.

### First Embodiment

### Configuration of Vehicle Driving Assistance Apparatus

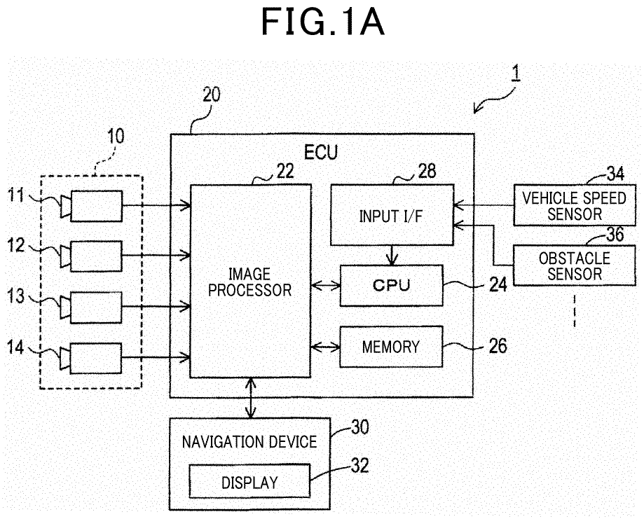

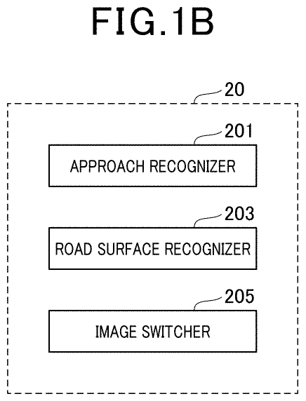

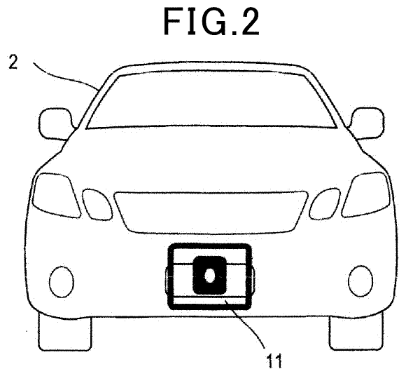

As illustrated in FIG. 1A, the vehicle driving assistance apparatus 1 of the present embodiment is mounted to a vehicle 2 as illustrated in FIG. 2, and is configured to display images captured by peripheral cameras 10 on a display 32 of a navigation device 30, thereby providing driving assistance to a driver of the vehicle 2. The vehicle driving assistance apparatus 1 includes an electronic control unit (ECU) 20 for image processing. The vehicle 2, that is, a vehicle carrying the vehicle driving assistance apparatus 1 is also referred to as a subject vehicle.

The peripheral cameras 10 are a set of four cameras 11, 12, 13, 14 mounted to the front, rear, left, and right sides of the vehicle 2 to capture images looking in the forward, rearward, leftward, and rightward directions of the vehicle 2, respectively.

Each of the cameras 11 to 14 includes a charge-coupled device (CCD) image sensor, a complementary metal-oxide semiconductor (CMOS) image sensor, or the like. The number of peripheral cameras 10 may be appropriately changed as needed. The front-view camera 11 mounted to the front center of the vehicle 2 as illustrated in FIG. 2 is a main part of this disclosure and images in the forward direction of the vehicle 2.

A wide-angle camera including a wide-angle lens is utilized as the front-view camera 11, such that a wide field of view for imaging in the forward direction of the vehicle 2 can be provided. The display 32 as the display device may be a liquid crystal display, a head-up display, or the like.

The ECU 20 is an electronic control unit (ECU) including an image processor 22 that processes captured images captured by the respective cameras 11 to 14, a CPU 24 that controls the image processor 22, and a memory 26 such as a ROM, a RAM or the like. That is, the ECU 20 includes a microcomputer having an image processing function.

The ECU 20 is also provided with an input I/F 28 to receive detection signals from various sensors that detect a traveling state of the vehicle 2 and an ambient condition of the vehicle 2, such as a vehicle speed sensor 34, an obstacle sensor 36 and the like, and inputs the detection signals to the CPU 24. the I/F represents an interface.

In the ECU 20, the CPU 24 performs a predetermined control process according to a program stored in the memory 26, and thereby gets aware of a vehicle state based on the detection signals received via the input I/F 28 and information acquired from other on-board devices.

The CPU 24 causes the image processor 22 to perform image processing in response to the vehicle state or a command from an occupant, and thereby generates a driving assistance image, such as a front-view image, a rear-view image, or a bird's-eye view image of surroundings of the vehicle 2 as viewed from above.

In addition, the image processor 22 generates the driving assistance image in response to a command from the CPU 24 and outputs the driving assistance image to the navigation device 30 to thereby switch the display image on the display 32 from the route guidance image to the driving assistance image. The route guidance image is a driving guidance image generated by the navigation device 30 based on map data.

### Image Switching Process at Intersection

As above, the CPU 24 causes the image processor 22 to generate the driving assistance image and switches the display image on the display 32 to the driving assistance image. When the vehicle 2 enters a blind intersection while the vehicle 2 is traveling, an image of an intersecting road that intersects the road of travel on which the vehicle 2 is currently traveling will be displayed on the display 32, which enables driving assistance for the driver that can identify a condition of the intersecting road.

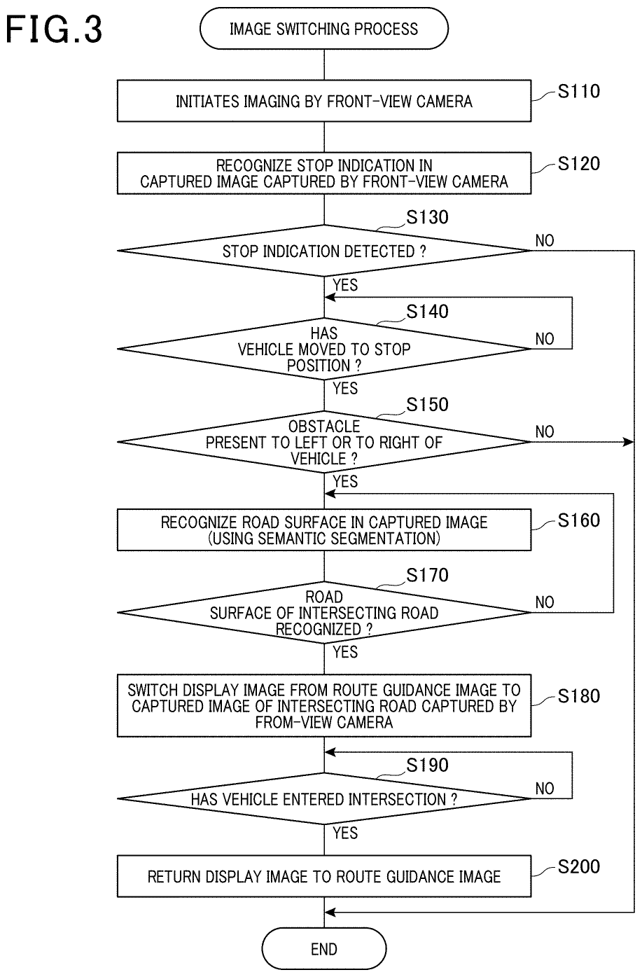

Hereinafter, the image switching process performed by the CPU 24 for driving assistance at such an intersection will be described with reference to a flowchart illustrated in FIG. 3.

The image switching process illustrated in FIG. 3 is one of processes that are repeatedly performed by the CPU 24 based on the detection signals from the vehicle speed sensor 34 when it is detected that the vehicle 2 is traveling.

In the image switching process, as illustrated in FIG. 3, the CPU 24 initiates imaging by the front-view camera 11 at step S110, and then at step S120 causes the image processor 22 to recognize a stop indication from an image captured by the front-view camera 11.

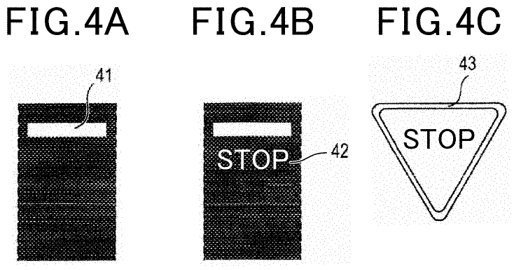

The stop indication may be any one of a stop line 41 on the road of travel as illustrated in FIG. 4A, a road marking 42 on the road of travel representing “STOP” as illustrated in FIG. 4B, and a road sign 43 representing “STOP” on or above the road side of the road of travel as illustrated in FIG. 4C. Then, the image processor 22 determines, using pattern recognition or the like, whether there is a stop indication in the captured image.

At step S130, the CPU 24 determines whether a stop indication has been detected in the captured image as a result of the recognition process by the image processor 22. If a stop indication has been detected, the process flow proceeds to step S140. If no stop indication has been detected, the process flow ends.

At step S140, the CPU 24 determines whether the vehicle 2 has moved to a stop position corresponding to the stop indication after detection of the stop indication.

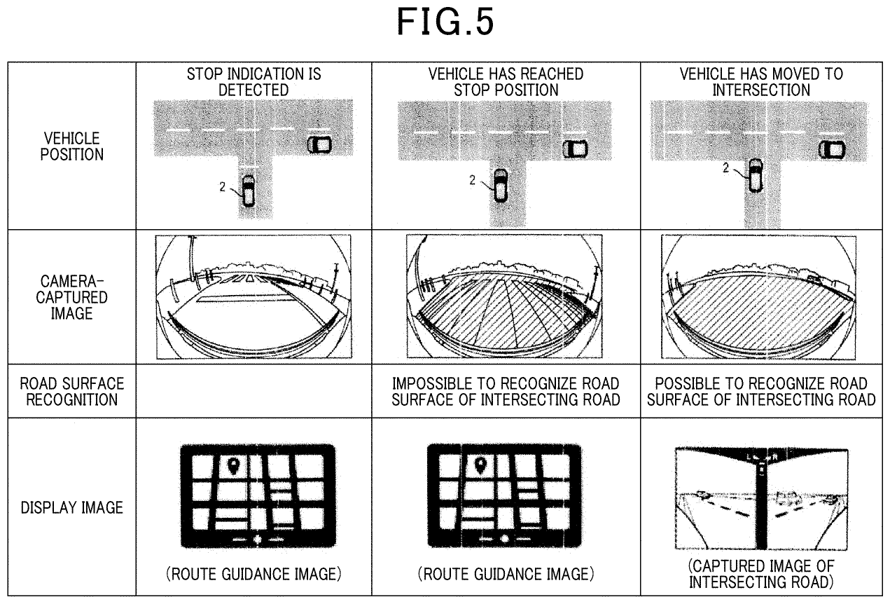

That is, as illustrated in the left column of FIG. 5, at a timing when the stop indication is detected in the image captured by the front-view camera 11, the vehicle 2 has not reached the stop position yet and is away from the stop position. Thus, at step S140, the CPU 24 waits for the vehicle 2 to move to and reach the stop position corresponding to the stop indication as illustrated in the center column of FIG. 5.

FIG. 5 illustrates a situation where, upon the vehicle 2 reaching the stop line on the road of travel, it is determined that the vehicle 2 has reached the stop position. At step S140, it may be determined that the vehicle 2 has reached the stop position when the stop indication is no longer imaged by the front-view camera 11. Alternatively, at step S140, it may be determined that the vehicle 2 has reached the stop position when the vehicle 2 has traveled a predetermined distance after detecting the stop indication.

If at step S140 it is determined that the vehicle 2 has moved to the stop position, the process flow proceeds to step S150. At step S150, using the obstacle sensor 36, the CPU 24 determines whether an obstacle to the left or to the right of the vehicle 2 has been detected. That is, at step S150, it is determined whether there is a parked vehicle other than the vehicle 2 or a building to the left or to the right of the vehicle 2 at the stop position, that is, whether there is an obstacle that causes the intersecting road to be less visible to the driver of the vehicle 2.

If no obstacles to the left and to the right of the vehicle 2 have been detected by the obstacle sensor 36, the CPU 24 determines that a view of the intersection that the vehicle 2 is about to enter is unobstructed and then terminates the image switching process.

If an obstacle to the left or to the right of the vehicle 2 has been detected by the obstacle sensor 36, the CPU 24 determines that the vehicle 2 is about to enter a blind intersection. The process flow then proceeds to step S160.

At step S160, the CPU 24 causes the image processor 22 to perform a road surface recognition process to divide the captured image captured by the front-view camera 11 into road surface areas and non-road-surface areas other than the road surface areas using, for example, semantic segmentation, and thereby recognize the road surface.

This process allows the image processor 22 to serve as a road surface recognizer 203 in this disclosure (see FIG. 1B). As illustrated in FIG. 5, the road surface area indicated by the hatching is recognized from the captured image captured by the front-view camera 11 after the vehicle has reached the stop position.

Semantic segmentation is, as disclosed in Japanese Patent No. 6309663, a known technique that uses machine learning data and the like to label which class of objects each of pixels forming an image belongs to. Therefore, in this specification, the description of a procedure for performing road surface recognition using semantic segmentation will be omitted.

After completion of the road surface recognition process at step S160, the process flow proceeds to step S170. At step S170, the CPU 24 determines whether a road surface of the intersecting road extending from the road of travel in the lateral direction is included in the road surface recognized by the image processor 22.

This determination may be made as follows. For example, if the road surface recognized by the image processor 22 broadens ahead of the vehicle 2 in the travel direction of the vehicle 2, it may be determined that the road surface of the intersecting road is included in the road surface recognized by the image processor 22. If the road surface recognized by the image processor 22 does not include the road surface of the intersecting road, it may be determined that the front-view camera 11 fails to image the intersecting road due to the presence of an obstacle. The process flow then returns to step S160, where the CPU 24 continues road surface recognition.

Subsequently, as illustrated in the right column of FIG. 5, when the vehicle 2 moves from the stop position toward the intersection and the front-view camera 11 is allowed to image the intersecting road, then the CPU 24, at step S170, determines that the road surface of the intersecting road is included in the road surface recognized by the image processor 22. The process flow then proceeds to step S180.

At step S180, the CPU 24 causes the image processor 22 to extract captured images of the left- and right-sides of the intersecting road from the captured image captured by the front-view camera 11, generate a driving assistance image including the captured images of the left- and right-sides of the intersecting road, and output the generated driving assistance image to the navigation device 30.

As a result, as illustrated in FIG. 5, the display image on the display 32 is switched from the route guidance image generated based on the map data by the navigation device 30 to the driving assistance image including the captured images of the left- and right-sides of the intersecting road.

Since the left-side and right-side of the intersecting road are appearing in the captured image captured by the front-view camera 11, the CPU 24 may, at step S180, output, as a driving assistance image, the captured image captured by the front-view camera 11 to the image processor 22 without performing image processing.

After, at step S180, the display image on the display 32 is switched from the route guidance image to the captured image of the intersecting road captured by the front-view camera 11, the process flow proceeds to step S190. At step S190, the CPU 24 determines whether the vehicle 2 has entered the intersection. That is, the CPU 24 waits for the vehicle 2 to enter the intersection at step S190.

If at step S190 it is determined that the vehicle 2 has entered the intersection, the CPU 24 causes the image processor 22 to return the display image on the display 32 from the captured image of the intersecting road captured by the front-view camera 11 to the route guidance image. Then, the process flow of the image switching process ends.

### Advantages

The vehicle driving assistance apparatus 1 as described above according to the present embodiment is configured to, in response to detecting a stop indication ahead of the vehicle in the travel direction in a captured image captured by the front-view camera 11 while the vehicle 2 is traveling, performs road surface recognition using the captured image after waiting for the vehicle 2 to move to a stop position corresponding to the stop indication.

The vehicle driving assistance apparatus 1 as described above according to the present embodiment is configured to, in response to recognizing a road surface of an intersecting road that intersects a road of travel at an intersection via road surface recognition, switch the display image on the display 32 from a route guidance image generated by the navigation device 30 to an image of the intersecting road captured by the front-view camera 11.

Therefore, the vehicle driving assistance apparatus 1 according to the present embodiment is configured to, in response to the road surface of the intersecting road being imaged by the front-view camera 11 immediately before the vehicle 2 enters the intersection, switch the display image on the display 32 to the image of the intersecting road.

Therefore, in cases where the road surface of the intersecting road fails to be imaged by the front-view camera 11, it is possible to inhibit the display image on the display 32 from being switched to the captured image captured by the front-view camera 11. That is, the vehicle driving assistance apparatus 1 according to the present embodiment is able to switch the display image at an appropriate timing that allows the front-view camera 11 to image the road surface of the intersecting road.

Therefore, the driver can be aware of a condition of the intersecting road from the switched display image, that is, the captured image of the intersecting road, and allows the vehicle to safely enter the intersection.

The vehicle driving assistance apparatus 1 according to the present embodiment makes a determination as to whether to switch the display images using the captured image captured by the front-view camera 11 and generates an image of the intersecting road to be displayed upon image switching.

Therefore, unlike the vehicle driving assistance apparatus as disclosed in JP-A-2007-140992, it is not necessary to provide an additional camera used to determine whether to switch the display images, which enables simplification of the overall configuration of the vehicle driving assistance apparatus. In addition, the vehicle driving assistance apparatus 1 according to the present embodiment is applicable to vehicles not equipped with any camera used to determine whether to switch the display images, which can expand applications of the vehicle driving assistance apparatus.

The vehicle driving assistance apparatus 1 according to the present embodiment is further configured to, when neither an obstacle to the left nor to the right of the vehicle 2 has been detected by the obstacle sensor 36 at a timing when the vehicle 2 moves to and reaches the stop position, that is, when the vehicle enters an intersection with unobstructed view, not display the captured image of the intersecting road.

Therefore, when the vehicle enters an intersection with unobstructed view, the display image on the display 32 will not be switched from the route guidance image to the captured image of the left and right sides of the intersecting road captured by the front-view camera 11, which can inhibit the display image from being switched unnecessarily.

In the present embodiment, as illustrated in FIG. 1B, the ECU 20 includes, as functional blocks, the approach recognizer 201, the road surface recognizer 203, and the image switcher 205. More specifically, the approach recognizer 201 is implemented by the CPU 24, in cooperation with the image processor 22, performing steps S120 to S140. The road surface recognizer 203 is implemented by the CPU 24, in cooperation with the image processor 22, performing step S160. The image switcher 205 is implemented by the CPU 24, in cooperation with the image processor 22, performing steps S150, S170 and S180.

### Other Embodiments

While the embodiments of the present disclosure have been described above, the present disclosure is not limited to the above-described embodiments, and may incorporate various modifications.

For example, in the image switching process of the above embodiment, if at step S130 it is determined that a stop indication has been detected in a captured image captured by the front-view camera 11, road surface recognition at step S160 is performed after waiting for the vehicle 2 to move to a stop position at step S140.

In an alternative embodiment, if at step S130 it is determined that a stop indication has been detected in a captured image captured by the front-view camera 11, road surface recognition at step S160 may be performed without making the determination at at step S140.

In the above embodiment, road surface recognition is performed using semantic segmentation to determine whether the front-view camera 11 has imaged the road surface of the intersecting road.

In an alternative embodiment, semantic segmentation may also be used for stop indication recognition at step S120. That is, using semantic segmentation, the captured image may be divided and classified into various areas, including a stop indication. Therefore, at step S120, semantic segmentation may be used to simultaneously recognize a stop indication, such as a stop line, and a road surface.

However, road surface recognition using semantic segmentation may fail to be accurately performed when surroundings are dark during nighttime or in bad weather, such as rainy weather. Thus, it may not be possible to correctly determine whether the road surface of the intersecting road has been imaged.

Therefore, during nighttime or in bad weather, the display image on the display 32 may be switched from the route guidance image to the image of left and right sides of the intersecting road captured by the front-view camera 11 without performing road surface recognition.

That is, during nighttime or in bad weather, the display image on the display 32 may be switched from the route guidance image to the image of the intersecting road captured by the front-view camera 11 if at step S130 it is determined that the stop indication has been detected or if at step S140 it is determined that the vehicle 2 has moved to the stop position or has arrived at the stop position.

In the above embodiment, a result of recognition of the stop indication by the image processor 22 is used to determine whether the stop indication has been detected at step S130. However, the intersection where an image of the intersecting road is to be displayed for driving assistance may be identified from the map data of the navigation device 30 or the like.

Therefore, at steps S120 to S140 that the approach recognizer 201 is responsible for, the approach to the intersection may be detected based on the map data and the current location of the vehicle 2. Even in such a configuration, when the vehicle 2 enters the intersection, the image of the intersecting road may be displayed on the display 32 to provide driving assistance to the driver.

In the above embodiment, when switching the display image on the display 32 to the image of the intersecting road, the route guidance image generated based on the map data by the navigation device 30 has been displayed on the display 32.

In an alternative embodiment, instead of the route guidance image, an information providing image that indicates a vehicle state, such as an operating state of an air conditioner, or an audio image, such as a television/video output or music playback screen.

In this way, even when an image other than the route guidance image is being displayed on the display 32, the display image on the display 32 may be switched to the image of the intersecting road by the image switching process described above when the vehicle 2 enters the intersection.

In addition, in the above embodiment, the functions of the approach recognizer 201, the road surface recognizer 203, and the image switcher 205 have been described as being implemented by the CPU 24 executing the program as the image switching process.

A technique for implementing these functions of the vehicle driving assistance apparatus 1 is not limited to software, but some or all of the functions may be implemented using one or more pieces of hardware. For example, in a case where these functions are implemented by an electronic circuit which is hardware, the electronic circuit may be implemented by a digital circuit including a number of logic circuits, an analog circuit, or a combination thereof.

A plurality of functions of one component in the above-described embodiments may be realized by a plurality of components, or one function of one component may be realized by a plurality of components. Further, a plurality of functions of a plurality of components may be realized by one component, or one function to be realized by a plurality of components may be realized by one component. Still further, portion of the components of the above-described embodiments may be omitted. In addition, at least portion of the components of the above-described embodiments may be added to or replaced with the components in another embodiment.

The present disclosure may be implemented in various modes including, as well as the vehicle driving assistance apparatus described above, a program for causing a computer to serve as the vehicle driving assistance apparatus, a non-transitory, tangible computer-readable storage medium, such as a semiconductor memory, storing this program, a driving assistance method, and others.

What is claimed is:

1. A vehicle driving assistance apparatus comprising:
an approach recognizer configured to recognize whether a vehicle has approached an intersecting road that is a road intersecting a road of travel on which the vehicle is traveling;
a road surface recognizer configured to recognize a road surface in an image of surroundings of the vehicle captured by a camera mounted to the vehicle;
an image switcher configured to, in response to the approach recognizer recognizing that the vehicle has approached the intersecting road, determine whether the road surface recognizer has recognized a road surface of the intersecting road, and in response to the road surface recognizer recognizing the road surface of the intersecting road, switch a display image on a display device mounted to the vehicle, for displaying driving guidance for the vehicle, to an image of the intersecting road captured by the camera.

2. The vehicle driving assistance apparatus according to claim 1, wherein
the approach recognizer is configured to, based on an image captured by the camera, recognize whether the vehicle has approached the intersecting road.

3. The vehicle driving assistance apparatus according to claim 1, further comprising an obstacle sensor configured to detect an obstacle to at least one of left and right of the vehicle,
wherein the image switcher is configured to, in response to the obstacle being detected by the obstacle sensor, switch the display image to the image of the intersecting road captured by the camera.

4. A vehicle driving assistance apparatus comprising:
a non-transitory memory storing one or more computer programs; and
a processor executing the one or more computer programs to:
recognize whether a vehicle has approached an intersecting road that is a road intersecting a road of travel on which the vehicle is traveling;
recognize a road surface in an image of surroundings of the vehicle captured by a camera mounted to the vehicle;
in response to recognizing that the vehicle has approached the intersecting road, determine whether a road surface of the intersecting road has been recognized, and
in response to determining that the road surface of the intersecting road has been recognized, switch a display image on a display device mounted to the vehicle, for displaying driving guidance for the vehicle, to an image of the intersecting road captured by the camera.
